(19) United States
(12) Patent Application Publication
(10) Pub. No.: US 2021/0307486 A1
(43) Pub. Date: Oct. 7, 2021

(54) Nail Pen Nib

(71) Applicant: Noushin Laaly, Los Angeles, CA (US)

(72) Inventor: Noushin Laaly, Los Angeles, CA (US)

(21) Appl. No.: 17/349,119

(22) Filed: Jun. 16, 2021

Related U.S. Application Data
(63) Continuation of application No. 16/392,530, filed on Apr. 23, 2019, now Pat. No. 11,058,205.
Application No. 16/392,530 is a continuation of application No. 15/360,651, filed on Nov. 23, 2016, now Pat. No. 10,306,969.
(60) Provisional application No. 62/260,222, filed on Nov. 25, 2015.

(51) Int. Cl. A45D 34/04; A45D 29/00; B43K 8/04; B43K 8/02

(52) U.S. Cl. CPC A45D 34/042; A45D 29/00; A45D 2029/002; B43K 8/022; B43K 8/04

(57) ABSTRACT

Provided is an assembly for a nail pen comprising: a) a nib made from a material that is configured to allow for movement of varnish from inside of the nail pen to the nib, and from the nib to a nail; b) a guide made from a material that is non-absorbent to the varnish, the guide extending below a surface of the nib that is configured to apply varnish to the nail; wherein a user applies a strip of the varnish to a distal portion of the nail by holding the guide against an edge of the nail and moving the nail pen along the distal portion of the nail so that the surface of the nib holding the varnish contacts the distal portion of the nail to apply varnish to the nail.

### CROSS-REFERENCE

The present application is a continuation of U.S. application Ser. No. 15/360,651, which claims the benefit of U.S. provisional patent appl. No. 62/260,222, filed on Nov. 25, 2015, which are incorporated herein by reference in their entirety.

### BACKGROUND SECTION OF THE INVENTION

A beautician-assisted or self-administered French manicure procedure may involve the application of varnish, or similar type of nail polish substance, exclusively along a uniform and dimensionally-consistent distal-most region of a nail. It is possible for the nail varnish to be spread unevenly onto the distal perimeter of a nail due to the shaking of the hand of the individual applying the nail varnish. Due to the fast-hardening chemical characteristics of nail varnish, any imperfections or inconsistencies with the distribution of nail varnish on the distal perimeter of the nail will become bound to the nail surface. The correction of any minor imperfection or inconsistency with the distribution of nail varnish would not be able to be fixed without the removal of any or all of the nail varnish applied to that distal outer perimeter. There is a need in the art for applying a French manicure without these drawbacks.

### SUMMARY SECTION OF THE INVENTION

Provided is an assembly of a nail pen nib and a nail pen guide. The assembly can beta single unit with a nail guide and a nib (applicator), the guide configured to contact with the edge of the nail tip and move along the edge of the nail tip so that varnish is applied from the nib (applicator) through the material of the nib (applicator) (particularly the bottom surface of the applicator) to only the distal portion of the nail (tip) to obtain a uniform strip of varnish, e.g., French manicure. The thickness of the French manicure can be from about 1 mm to about 10 mm (1 cm), such as about 2 mm to about 7 mm.

The guide and the nib (applicator) can be made as a single unit assembly. The guide can be made from a hard material that can be pressed against the edge of the nail tip such metal (stainless steel), non-metal, synthetic, polymer, plastic, and/or UItem resin. The guide can be non-absorbent and non-permeable so not to absorb the varnish and minimize smearing on the finger tip and surrounding.

The portion of the guide that is exposed can have a Teflon (Polytetrafluoroethylene) coating. The nib (applicator) can be made from a material that allows the varnish to move from one end of the nib (applicator) in fluid communication with a source of varnish to the other end of the applicator configured to deliver varnish to the distal portion of the finger tip. Varnish can move through the nib (applicator) such as by diffusion and/or gravitation force or other force. The applicator can have substantially parallel fibers (or other non-parallel configurations) that are oriented from one end of the applicator to another end of the applicator. The applicator can be made from an absorbent material and/or a material with a high number of pores.

The nib (applicator) and the guide can be made into a single unit assembly. The unit assembly can be made from molding together nib (applicator) part(s) and guide part(s). The assembly can have a body with a uniform diameter comprised of both the nib (applicator) and the guide. The guide extends out of the bottom of the nib so to contact the edge of the nail tip. The assembly unit can be made by molding the guide and the nib (applicator) together. In one embodiment, adhesive may or may not be used to make unit. The adhesive can be gel-type to avoid absorption by the nib. The guide and the nib (applicator) can together run along (the guide can run through at the center) the body of the unit and can together be exposed at the top of the unit. The body of the nib can have a step, which is a reduction in diameter of the body. The top of the assembly can be received by a receiver (such as in the shape of a cup), so that when a user presses down the nib (for example on a nail, or a table), a force is applied to the receiver, opening a valve for receiving varnish from the barrel of the nail pen. By having the guide run across the entire unit and touch the receiver, the guide remains in a stable position in the nib unit. Alternatively, the guide is stabilized by a step in the nib adhesives, and/or other methods.

The guide can have a guide body, a member (such as a cylindrical rod) for contacting with the receiver in the nail pen, and a connector for connecting the member to the guide body. The guide can be fabricated from one piece material, and having these parts be incorporated into a single piece.

Alternatively, the guide can be made so it only has a guide body with no other member and makes no contact with a receiver in the nail pen. The member of the guide contacting the receiver can be coaxial with the applicator, and can form the center of the cylindrical assembly unit, with the nib (applicator) surrounding the member, which may itself be a cylinder. The nail guide can be inside the applicator in the nib in the middle and top of the nib, and then move to the periphery at the bottom of the nib and be exposed on the outside of the body.

Provided is an assembly for a nail pen comprising: a) a nib made from a material that is configured to allow for movement of varnish from inside of the nail pen to the nib, and from the nib to a surface of a nail; b) a guide made from a material that is non-absorbent to the varnish, the guide extending below a surface of the nib that is configured to apply varnish to the nail; wherein a user applies a strip of the varnish to a distal portion of the nail by holding the guide against an edge of the nail and moving the nail pen along the distal portion of the nail so that the surface of the nib holding the varnish contacts the distal portion of the nail to apply varnish to the nail; wherein the nib and, the guide are in an assembly. The assembly can be configured to be removable from the nail pen. The assembly can be cylindrical shaped. The guide can be configured as a sleeve to be placed on an outside portion of the nib. The nib can have an upper portion with a larger diameter than a lower portion with a smaller diameter, and the guide is placed on the lower portion of the nib with the smaller diameter. The sleeve and the nib can form a uniform surface. The top of the guide can be exposed on a top surface of the nib that is configured to be placed inside of the nail pen. The nib can be made from a single fabricated piece of the absorbent material, the nib having a channel inside at least along its top one fifth portion. The guide can be configured to be on outside of the nib in an end of the nib configured to contact the nail, and the guide is configured to be inside of the nib in an end of the nib configured to contact a component of the nail pen. The guide can be configured to be placed in a groove that is, on an outer surface of the nib. The guide and the nib can be coaxial at least in the top half end of the nib configured to contact the nail pen. The guide and the nib can be coaxial with the guide running along a central axis of the nib, the guide further extending outside of an end of the nib. The guide after coming out from a bottom of the nib, can expand in dimension in a perpendicular direction. A portion of the guide outside of the nib is larger in perpendicular direction that the portion of the guide inside of the nib. The assembly can be configured to be placed in a cavity at a bottom end of the nail pen. The nib and/or the guide can have a step. The nib and the guide can be stabilized in the assembly with one or more rings. In one embodiment, the nib and the guide are not coaxial. The nib and the guide can be coaxial. In one embodiment, the guide is not attached directly to the nail pen.

Provided is an assembly for attaching to a nail pen holding varnish comprising: a) a nib made from a material that is configured to allow for movement of varnish from inside of the nail pen to the nib, and from the nib to the nail, the nib further configured to make contact with a mechanism in the nail pen that is configured to allow for flow of varnish to the nib when the nib is pressed against the nail; b) a guide made from a material that is non-absorbent to varnish, the guide extending below a surface of the nib that is configured to apply varnish to the nail; wherein a user applies the varnish to a distal portion of the nail by holding the guide against an edge of the nail and moving the nail pen along the distal portion of the nail so that the surface of the nib holding varnish contacts the distal portion of the nail. Both the guide and the nib can make contact with the mechanism. Provided is a nail pen comprising: a) a nib made from a material that is configured to allow for movement of varnish from inside of the nail pen to the nib, and from the nib to a nail; b) a guide made from a material that is non-absorbent to varnish, the guide extending below a surface of the nib that is configured for applying varnish to the nail; c) a push button mechanism that is configured to allow for flow of varnish to the nib when the button is pressed by a user; and wherein a user applies the varnish to a distal portion of the nail by holding the guide against an edge of the nail and moving the nail pen along the distal portion of the nail so that the surface of the nib holding varnish contacts the distal portion of the nail; and wherein the nib and the guide are in an assembly. Provided is a nail pen comprising: a) a nail pen housing inside of which is a reservoir for varnish; b) a valve to stop flow of varnish; c) a mechanism configured to be actuated by a user to open the valve and allow varnish to flow to other side of the valve; d) a nib made from a material that is configured to allow for movement of varnish from inside of the nail pen after the valve and to the nib, and from the nib to a nail; and e) a guide that is non-absorbent to the varnish, the guide extending below a surface of the nib that is configured to apply varnish to the nail; wherein a user applies a strip of the varnish to a distal portion of the nail by holding the guide against an edge of the nail and moving the nail pen along the distal portion of the nail so that the surface of the nib holding the varnish contacts the distal portion of the nail to apply varnish to the nail; wherein the nib and the guide are in an assembly.

Provided is a nail pen comprising: a) a nib made from a material that is configured to allow for movement of varnish from inside of the nail pen after the valve and to the nib, and from the nib to a nail; and b) a guide that is made from a material that is not absorbent to the varnish, the guide extending below a surface of the nib that is configured for applying varnish to the nail; c) a nail pen housing inside of which is a reservoir for varnish, the nail pen having a cavity at one end configured to receive the nib; wherein a user applies a strip of the varnish to a distal portion of the nail by holding the guide against an edge of the nail and moving the nail pen along the distal portion of the nail so that the surface of the nib holding the varnish contacts the distal portion of the nail to apply varnish to the nail. A portion of the nib-guide assembly that can be placed inside of the cavity is cylindrical in shape. Both the guide and the nib can go inside of the cavity. Only the nib can go inside of the cavity. A mechanism can be configured to be actuated by a user to open the valve and, allow varnish to flow to other side of the valve. Provided is a method of applying a band of varnish to a distal portion of a nail comprising: a) placing a nib-guide assembly that is cylindrical in shape in an opening of a nail pen, wherein the guide is non-absorbent to varnish and the nib is absorbent, the guide further extending below a lowest surface of the nib; b) placing the guide of the nail pen against the edge of the nail; c) placing the nib against the nail; and d) moving the nib on the distal portion of the nail to apply varnish to the nail.

Provided is a nib for a nail pen comprising a cylindrical body configured to allow for movement of varnish from proximity to a top end of the body to a bottom end of the body, the cylinder further comprising a step between a lower portion and an upper portion of the cylinder, the upper portion of the cylinder having a larger diameter, a bottom of the lower portion of the nib configure doe contacting a surface of a nail. The upper portion of the nib can further comprise an additional step at the top end of the nib, the step at the top end resulting in a top portion with a smaller diameter.

Provided is a nail pen comprising: a) a nail pen housing inside of which is a reservoir for varnish; b) a valve to stop flow of varnish; c) a mechanism configured to be actuated by a user to open the valve and allow varnish to flow to other side of the valve; d) a nib made from a material that is configured to allow for movement of varnish from inside of the nail pen after the valve and to the nib, and from the nib to a nail; e) a guide that is non-absorbent to the varnish, the guide extending below a surface of the nib that is configured to apply varnish to the nail; and f) a cavity at one end of the nail pen configured to receive the nib; wherein a user applies a strip of the varnish to a distal portion of the nail by holding the guide against an edge of the nail and moving the nail pen along the distal portion of the, nail so that the surface of the nib holding, the varnish contacts the distal portion of the nail to apply varnish to the nail; wherein the nib and the guide are in an assembly.

### BRIEF DESCRIPTION OF THE FIGURES

FIG. 1 illustrates an exploded view of a nail pen.

FIG. 2 illustrates an exploded view of valve/pump with nib/guide assembly.

FIG. 3 illustrates a side view of a nail pen.

FIG. 4 illustrates an cross section of a nail pen.

FIG. 5 illustrates a nib-guide assembly (overmold) (iso front view).

FIG. 5a illustrates a nib-guide assembly (overmold) (iso back view).

FIG. 5b illustrates a nib-guide assembly (overmold) (iso front view).

FIG. 5c illustrates nib-guide assembly (overmold) (cross section).

FIG. 6 illustrates a guide connected to a shaft (isometric view).

FIG. 6a illustrates a guide connected to a shaft (side view).

FIG. 6b illustrates a guide connected to a shaft (back view).

FIG. 6c illustrates a guide connected to a shaft (front view).

FIG. 7 illustrates a nib (isometric back view).

FIG. 7a illustrates a nib (side view).

FIG. 7b illustrates a nib (back view).

FIG. 7c illustrates a nib (front view).

FIG. 8 illustrates a nail pen applying a band of varnish (isometric view).

FIG. 8a illustrates a nail pen applying a band of varnish (isometric view).

FIG. 9 illustrates positioning a nail pen against a nail surface before and after the nail pen is pressed against the nail.

FIG. 10 illustrates a nib-guide assembly.

FIG. 10a illustrates a nib-guide assembly.

FIG. 10b illustrates a nib-guide assembly (exploded view).

FIG. 10c illustrates a nib-guide assembly.

FIG. 10d illustrates a nib-guide assembly.

FIG. 11 illustrates a nib-guide assembly (rear view).

FIG. 11a illustrates a nib-guide assembly (side view).

FIG. 11b illustrates a nib-guide assembly (exploded view).

FIG. 11c illustrates a nib-guide assembly (iso rear bottom view).

FIG. 11d illustrates a nib-guide assembly (iso rear top view).

FIG. 12 illustrates a nib-guide assembly (rear view).

FIG. 12a illustrates a nib-guide assembly (side view).

FIG. 12b illustrates a nib-guide assembly.

FIG. 12c illustrates a nib-guide assembly (iso rear bottom view).

FIG. 12d illustrates a nib-guide assembly (iso rear top view).

FIG. 13 illustrates a center guided nib (front view).

FIG. 13a illustrates a center guided nib (cross section view).

FIG. 13b illustrates a center guided nib (side view).

FIG. 13c illustrates a center guided, nib (iso top view).

FIG. 13d illustrates a center guided nib (iso bottom view).

FIG. 14 illustrates a ferrule guided nib (side view).

FIG. 14a illustrates a ferrule guided nib (front view).

FIG. 14b illustrates a ferrule guided nib (iso top view).

FIG. 14c illustrates a ferrule guided nib (iso bottom view),

FIG. 14d illustrates a ferrule guided nib (cross section view).

FIG. 14e illustrates a ferrule guided nib (iso rear bottom view).

FIG. 14f illustrates a ferrule guided ring (iso rear bottom view).

FIG. 15 illustrates a rear push button manicure applicator (iso top view).

FIG. 16 illustrates a rear push button manicure applicator (exploded view).

FIG. 17 illustrates a valved container (exploded view).

FIG. 18 illustrates a valve/pump assembly (exploded view).

FIG. 19 illustrates a ferrule guided nib assembly (exploded view).

FIG. 20 illustrates a push button French manicure applicator normal position (side view).

FIG. 20a illustrates a push button French manicure applicator normal position (cross section).

FIG. 21 illustrates push button French manicure applicator pressed position (side view).

FIG. 21a illustrates a push button French manicure applicator pressed position (cross section).

FIG. 22 illustrates another embodiment of a center guided nib of FIG. 13 (cross-section).

FIG. 23 illustrates the ferrule design with a smaller guide.

FIG. 24 illustrates a guide that runs along the center of a cylindrical nib (cross-section).

FIG. 25 illustrates a guide bending towards a nib (cross-section).

FIG. 26 illustrates a guide positioned on outside of the nib extending below the nib and bending towards the nib (cross-section).

FIG. 27 illustrates a guide positioned on outside of the nib extending below the nib in a straight form without bending (cross-section).

FIG. 28 illustrates a ring around a nib, and a guide attached to the ring and extending below the lowest surface of the nib for contacting the nail.

FIG. 29A illustrates an assembly of a guide with rings and a nib with grooves.

FIG. 29B illustrates a nib with a groove.

FIG. 29C illustrates an exploded view of a guide and a nib.

FIG. 29D illustrates an exploded view of a guide and a nib.

FIG. 30 illustrates a nail pen with a guide.

FIG. 31 illustrates a ferrule design with a shorter height.

FIG. 32 illustrates a ferrule design with a step/recess.

### DETAILED DESCRIPTION OF THE INVENTION

The present invention obviates this dilemma by presenting an apparatus for applying nail varnish in a controlled, uniform manner along the distal perimeter of a nail with significantly fewer imperfections or inconsistencies with the distribution of nail varnish on the distal nail perimeter. As used herein, distal portion of the nail refers to the edge of the nail exposed at the finger tips.

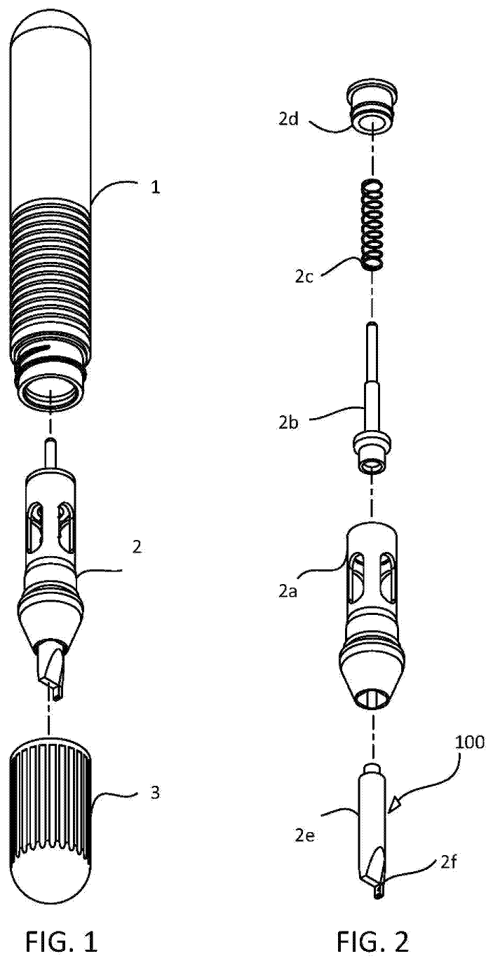

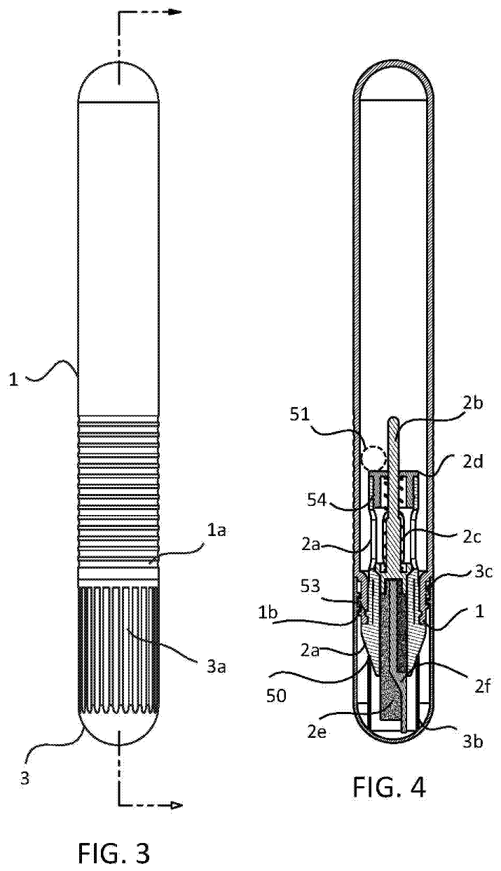

FIG. 1 illustrates the components of a nail pen, which include barrel 1, valve pump nib assembly 2 (connected together), and optional cap 3. Barrel 1 can be made from a hollow cylinder with one closed end and one open end, inside of the cylinder configured to store varnish. Valve pump nib assembly 2 is placed in the open end of barrel 1. Barrel 1 can have thread on the inside of its, open end that are complementary to threads on valve pump nib assembly 2, and can be attached together by the complementary threads. Cap 3 can be attached to barrel 1 to avoid exposure of valve pump nib assembly 2 to air. Cap 3 can have threads and be attached to threads on outside of open end of barrel 1. FIG. 3 illustrates nail pen with cap 3 coveting the valve pump nib assembly 2.

FIG. 2 illustrates components of valve pump nib assembly 2. Nib 2e (part projecting out of the opening of the nail pen) and nib guide 2f form a unitary piece that is placed inside of valve housing 2a. Valve housing 2a has a circular opening at its bottom and top, and a channel inside, which are configured to receive nib 2e and allow for movement of nib 2e inside of housing 2a in response to a force applied to unit 2e. Top of nib 2e is complementary to bottom of valve door 2b. The circular cavity on bottom of valve door 2b receives top portion of nib 2e. Valve door 2b also has a stem portion, over which spring 2e is placed. Stem of valve door 2b has two different diameters, with lower portion of the stern having a larger diameter (thicker). Valve compression spring retainer 2d is placed on the top opening of valve housing 2a. Valve compression spring retainer 2d snaps in, and can maintain lower portion of valve door 2 inside of housing. When nib 2e is pressed against the nail, nib 2e puts an upward pressure of valve door 2b. Valve door 2b moves upward as regulated by spring 2c. In ordinary position without compression, top of stem of valve door 2e goes through an opening on top of valve compression spring retainer 2d (see FIG. 1). When nib 2e moves upward, valve door 2b also moves upward. The upward motion of valve door 2b is limited by the larger diameter of lower portion of stem of valve door 2b. The lower portion of stem of valve door 2b does not fit through the opening of valve compression spring retainer 2d, maintaining the lower portion of stem of valve door 2b at all times inside of valve housing 2a.

FIG. 3 illustrates the nail pen of FIG. 1 with cap 3. The cap 3 can have a cap screw knurl 3a.

FIG. 4 is a cross section view of the nail pen illustrated in FIG. 3. Nib 2e and guide 2f are complementary and form a cylinder. Guide 2f comes down further than nib 2f so to contact the edge of a nail. Bottom of nip 2e is configured to contact a person's nail and transfer varnish to the nail. The top of nib 2e has a portion with a smaller diameter, which is configured to fit into cavity of valve door 2b. Valve door 2b has a stem of varying diameter, with a top portion of a smaller diameter configured to slidably pass through opening of valve spring retainer 2d. The lower stem portion of valve door 2b cannot pass through opening of valve spring retainer 2d, and is limited in its motion. Nib 2e and valve door 2b are maintained in valve housing 2a, and slide in a channel that runs through valve housing 2a in a vertical direction. Valve spring retainer 2d snaps to top of the valve housing 2a, and seals the top end of the vertical channel in valve housing 2a other than for a small opening that is configured to allow movement of the upper stem portion of valve housing 2b. Agitator ball 51 allows for mixing the varnish by moving the nail pen. Nozzle 50 has an opening cavity inside for placing nib assembly 100.

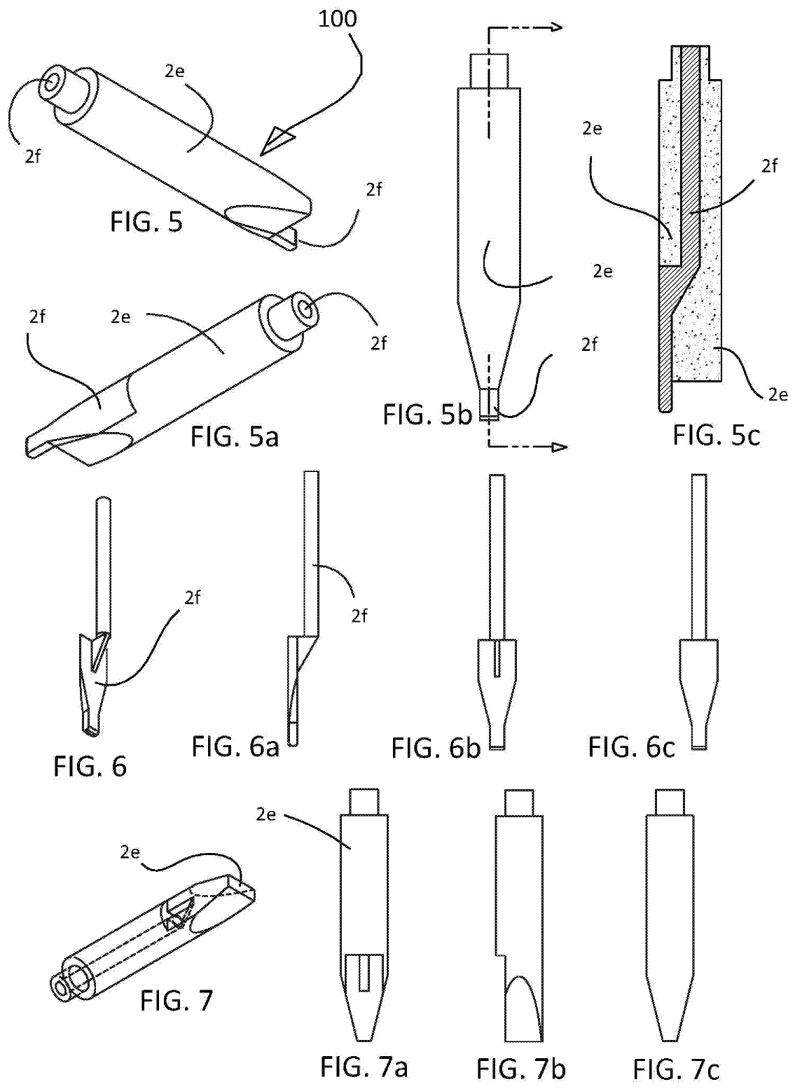

FIG. 5 illustrates a single unit comprising of both nib 2e and guide 2f. As illustrated in FIGS. 5a, 5b, and 5c, nib 2e has a cylindrical shape with a top portion having a diameter smaller than the diameter of the body of nib 2e. The bottom of nib 2e tapers down to form a rectangle-shaped contact surface for contacting the nail. In all embodiments of the present invention, other nib shapes can be used, including those that make contact with the nail with a circular pointed bottom (like a traditional pen or pencil). Alternative nib shapes for surface of the nib contacting the nail can he oval, semi-circle, or square. The assembly of the guide and the nib in any embodiment can be cylindrical (circle), oval, semi-circle, rectangle, and square.

FIG. 6 (and FIGS. 6a, 6b, 6c) illustrates nib guide 2f of FIG. 5. As illustrated in FIGS. 6, 6a, 6b, and 6c, guide 2f has a guide portion that is configured for contacting the edge of a nail and a rod portion configured to run in the center of nib 2e in a vertical direction. The guide and the rod portions can be formed as a weldment. The contact portion of guide 2f is positioned on outside of nib 2e, and can be shaped to form a uniform cylindrical body with nib 2e. Rod portion of nib guide 2f is configured to contact valve door 2b and can be co-axial with nib 2e.

FIG. 7 (including FIGS. 7a, 7b, 7c) illustrates nib 2e without nib guide 2f. Nib 2e has a bottom rectangular surface configured to contact a nail and apply varnish to the nail. FIGS. 7a and 7b illustrate portions in nib 2e that are configured to receive guide 2f, Nib 2e also has a channel running along inside at its center configured to accept the rod of guide 2f.

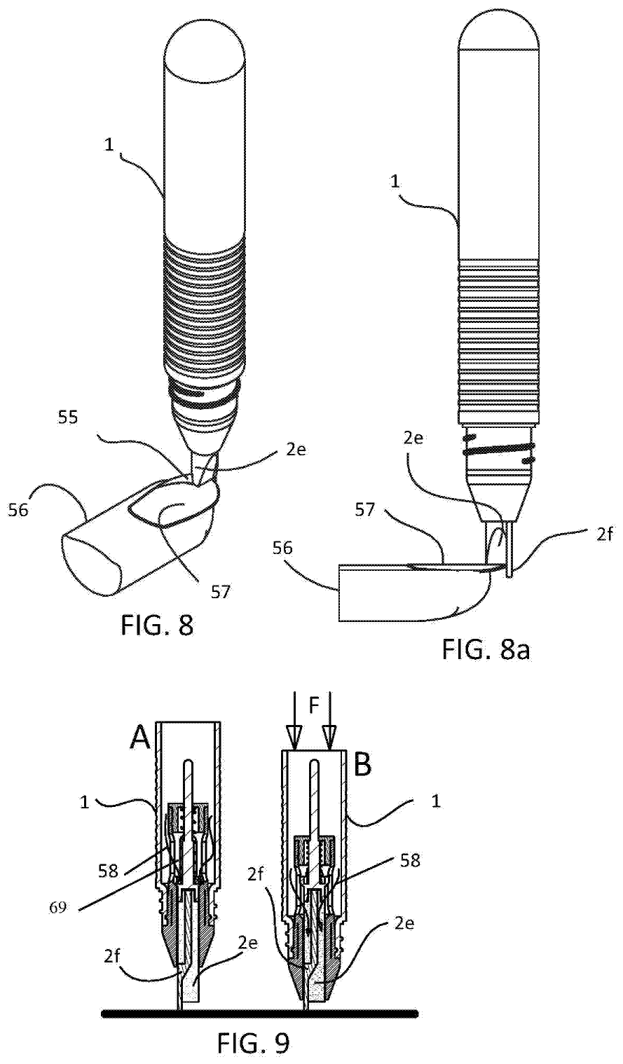

FIGS. 8 and 8a illustrate application of a French manicure to a distal portion of the nail. French manicure is a style of manicure in which the nails 56 of finger 57 are painted with a band of varnish at the tip. The band 55 is typically white. The white band at the tip of the nail is approximately equidistant from the edge of the nail, requiring a steady hand to apply the band of varnish, which is typically white. As illustrated in these figures, the nail pen is held in the hand by its barrel 1. The nail pen is moved from one side of the nail 57 to other side at the edge of nail 57. Guide 2f is held against edge of the nail and limits how far nib 2e can travel to the proximal portion of the nail. A user moves the nail pen by positioning the nail pen's guide 2f against the edge of nail 57, and then moving the nail pen from one side of nail 57 to another side to apply a band of French manicure 55. The guide 2f can be smaller in length and/or narrower than that illustrated in FIG. 8a, and only slightly extend below the nail. Guide 2f can be curved or slightly angled towards the nail.

FIG. 9 illustrates actuating the valve of the nail pen to allow varnish 58 flow from inside of barrel 1 which has a varnish 58 reservoir through the side openings 69 on valve housing 2. The varnish 58 then travels from the side openings 69 that are in proximity to the top of nib 2e to bottom of nib 2e. When not in use (A), the valve is closed by valve door 2b. When nib 2e of nail pen is pressed against nail 57, nib 2e pushed up valve door 2b, resulting in varnish 58 making physical contact with nib 2e. The movement in figure nine is exaggerated for illustration purposes. The nail pen needs to move slightly down for the varnish to release.

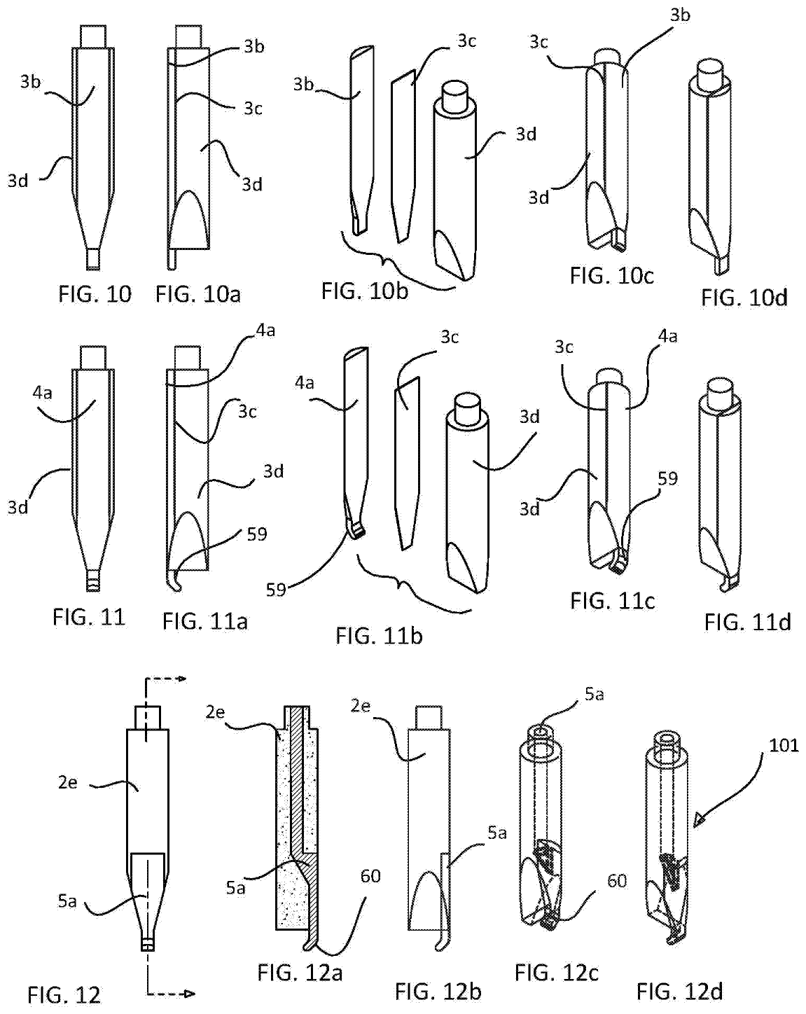

FIG. 10 illustrates an alternative manner to construct an assembly of a nib and a guide. In this embodiment, illustrated in FIGS. 10, 10a, 10b, 10c, 10d, nib 3d is attached to guide 3b through adhesive 3c. Guide 3b can have a flat inside flat surface which complements a flat side of nib 3d. Guide 3b runs along the length of nib 3d. Guide 3b is flat on the inside arid circular/curved on the outside, so that after attachment to nib 3d, forms a cylindrical assembly. As illustrated in FIGS. 10c and 10d, the portion of guide 3b extends below the bottom rectangular surface of nib 3d and is positioned on the short side of the rectangular surface. Guide 3b can be made from a metal, non-metal, or a rigid synthetic material like plastic.

FIGS. 11 (and 11a, 11b, 11e, 11d) illustrates the same assembly as FIG. 10. In this case the portion of the guide extending below the rectangular bottom surface of nib 3d is also positioned on the short side of the rectangle. In this embodiment, the guide curves and/or bends 59 towards the bottom surface of nib 3d. The guide can bend in a straight fashion at an angle or in a curved fashion. FIG. 27 illustrates another embodiment where guide 3b extends below the nib 3d and remains straight without bending. FIG. 26 illustrates the guide 4a bending at an angle towards the nib 3d when it goes below the lower surface of nib 3d.

FIGS. 12 (and 12a, 12b, 12c, 12d) illustrate the same assembly as FIG. 5 except in this case the portion of the guide 60 extending below the rectangular bottom surface of nib 2e curves or bends at an angle towards the bottom surface of nib 2e. In FIG. 12, the guide 60 has a first vertical portion that extends below the lowest surface of the nib 2e and a second portion that bends towards nib 2e. In FIG. 25, the guide 60 immediately bends at an angle towards nib 2e without having a vertical portion below the nib surface.

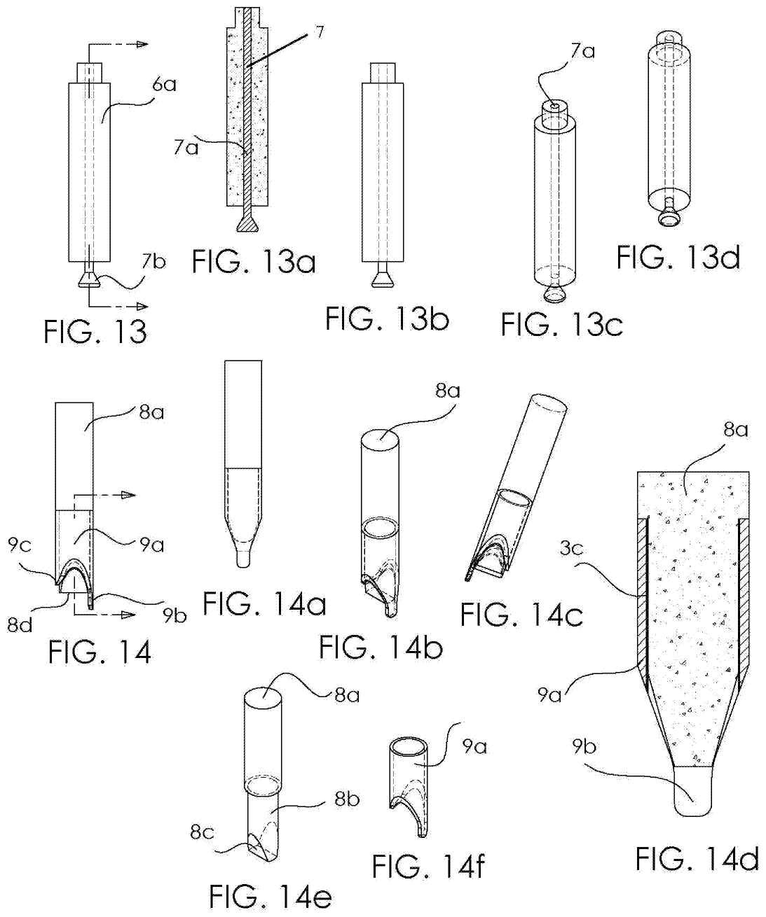

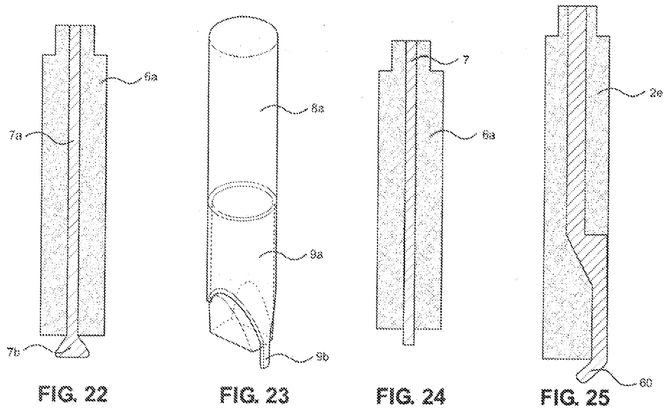

FIG. 13 (and FIGS. 13a, 13b, 13c, 13d) illustrate a nib assembly with the guide 7 (7a) running along the center of the cylindrical nib 6a. The guide 7 has a shaft 7a that runs along the center of nib 6a. The guide 7 also has a pin head 7b. In one embodiment, shaft 7a extends below nib 6a to create a gap (between pin head 7b and bottom of nib 6a) for placing tip of the nail before shaft 7a expands to form pin head 7b. In another embodiment, as illustrated in FIG. 22, a smaller or a minimal gap exists between pin head 7b and bottom of nib 6a. Pin head 7b is formed at the bottom portion of shaft 7a and can have a curved conical frustum shape, increasing in diameter as extending below nib 6a. In another embodiment, illustrated in FIG. 24, the guide 7 runs along the center of the cylindrical nib 6a and comes out of the bottom surface in the same shape without forming a pin head. The guide 7 can be a cylinder with a diameter of the typical staple.

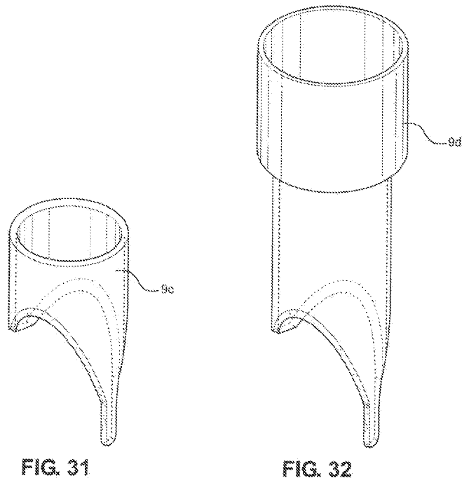

FIG. 14 (and FIGS. 14a, 14b, 14e, 14d, 14e, and 141) illustrate a guide 9b with a body ferrule 9a that forms a sleeve around nib 8b. The ferrule body 9a is like a sleeve or an empty cylinder that wraps around nib 8b. Nib 8b can have a smaller diameter than the upper portion of nib 8a to complement and receive the ferrule body 9a, and to maintain the ferrule body 9a in place. As illustrated in FIG. 14d, ferrule body 9a and the top portion of nib 8a are flush to each other and form a uniform surface. The lower sides of guide 9a can have curved shaped void portions (ferrule recessed sides 9c) and correspond to the contour of nib 8a. Guide 9b extends further below the lowest portion of nib 8b and is configured to contact tip of a nail. An adhesive 3c can be use used to attach ferrule body 9a to nib 8b. In one embodiment, in this nib-guide assembly, in anon-deployed position, the top portion of nib 8a is placed inside an opening at the bottom of a nail pen, and ferule body 9a can stay completely or partially outside of the opening and either go or not go inside of the nail pen. In another embodiment, ferrule body 9a covers more than 50% of outside of nib 8a (such as 100%), and both ferrule body 9a to nib 8a are placed at least partially inside of the opening of the pen in a non-deployed position. In another embodiment, ferrule body 9a covers 10 to 30% or 30% to 50% of outside of the nib 8a. As illustrated in FIG. 23, in one embodiment, guide 9b has a smaller width than the side of nib 8a, which corresponds to one side of the rectangular bottom surface making contact with the nail. Nib 8a has a step or a recess that stabilizes the assembly. FIG. 31 illustrates Ferrule/sleeve 9c with a shorter height (the ring portion is smaller). FIG. 32 illustrates a ferrule/sleeve 9d with a step that complements the step of nib 8a.

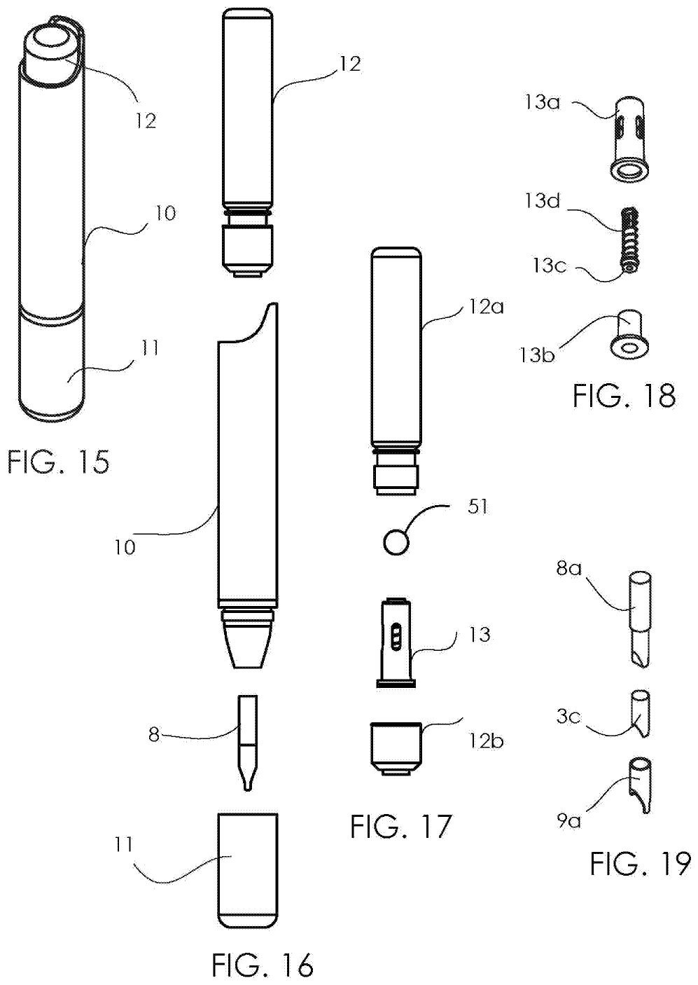

FIG. 15 illustrates manicure nail pen (perspective top view) with atop push button 12. The nail pen has body 10, cap 11, and valved container 12. The top of valved container 12 is accessible from outside of body 10 and acts as a button that can be pushed to release varnish from the barrel 1 to a nib.

FIG. 16 illustrates components of the nail pen of FIG. 15 (exploded, view). The components of the nail pen include body 10, cap 11, and valved container 12. Valved container 12 is placed inside body 10 and slide against inside of body 10 when pressed from the top. The top of valved container 12 is exposed and accessible to a user to press down. Nib 8 (such as that configured to receive ferrule 9a) is placed inside the opening (cavity) at bottom end of body 10.

FIG. 17 illustrates components of valved container 12 (exploded view). Valved container 12 can include manicure liquid container 12a which holds the varnish inside. Valved container 12 can further include cap 12b, Valve/pump assembly 13, and agitator ball 51. Varnish enters the Valve/pump assembly 13 from openings on the side 69 and exits the Valve/pump assembly 13 through an opening at the bottom of the assembly 13 and then an opening in cap 12b. FIG. 31 illustrates ferrule 9c where the portion that goes around the nib has a lower height (a ring with a thin band). FIG. 32 illustrates ferrule 9d where the ferrule has a step that complements the step in nib. Ferrule 9d has a lower portion and an upper portion, with the upper portion having a slightly larger diameter that forms a recess/step with the lower portion.

FIG. 18 illustrates valve/pump assembly 13 (exploded view) having valve/pump housing 13a, valve seat 13b, valve 13c, and compression spring 13d.

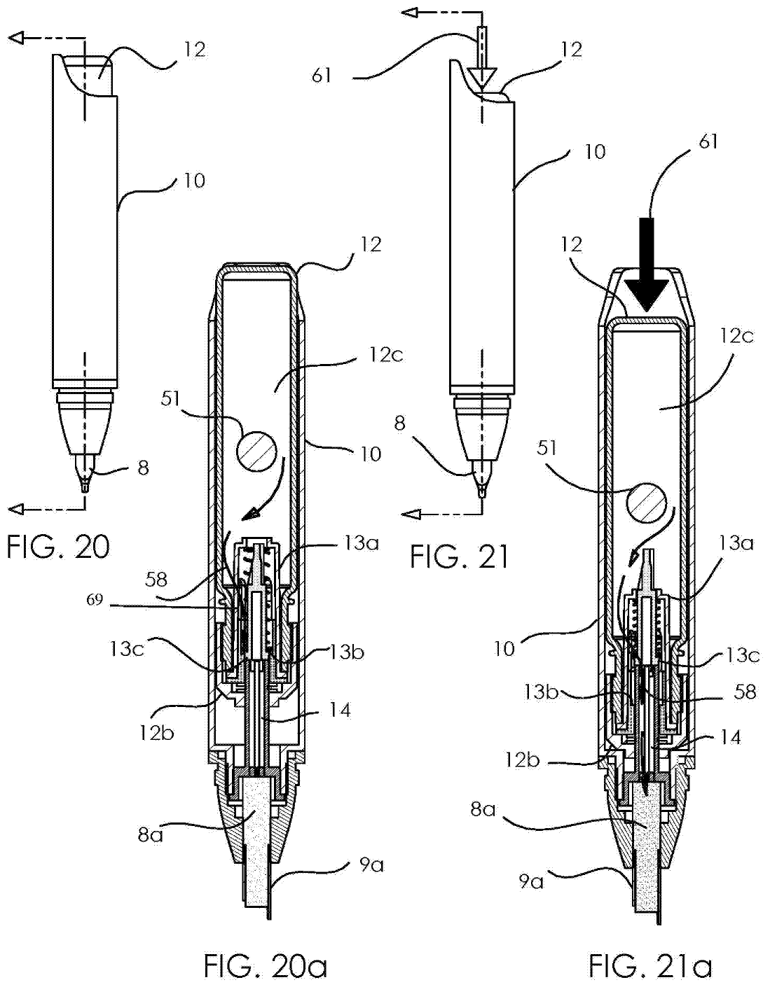

FIG. 19 illustrates ferrule guided nib assembly (exploded view) with adhesive 3c (gap filling ultra-gel control for example LOCTITE ultra-gel adhesive), nib 8a, and ferrule body 9a. Nib 8a has a lower diameter in the bottom portion and is configured to accept Ferrule body 9a at the lower portion.

FIG. 20 illustrates a push button French manicure applicator (nail pen) in a normal position (non-deployed) (side view) with nib-guide assembly (such as ferrule guided nib assembly 8), Body 10, and valved container 12.

FIG. 20a illustrates a push button French manicure nail pen in a normal position (cross section) (non-deployed) with nib 8a, ferrule body 9a, body 10, valved container 12, container cap 12b, Manicure liquid (varnish) 12c, valve Housing 13a, valve seat 13b, valve 13c, manicure liquid feed channel 14, agitator ball 51, and varnish flow 58. In this position the valve assembly is closed since valve 13c is sitting on valve seat 13b. Valve 13c is in a closed position and varnish is not moving to nib 8a.

FIG. 21 illustrates a push button French manicure nail pen of FIG. 20 in a pressed position (deployed) (side view). The button 12 is pushed or pressed in a downward direction 61.

FIG. 21a illustrates a push button French manicure nail pen in a pressed position (cross section). The nail pen is illustrated with nib 8a, ferrule body 9a, body 10, valved container 12, container cap 12b, manicure liquid (varnish) 12c, valve housing 13a, valve seat 13b. Valve 13c, manicure liquid feed channel 14, agitator ball 51, varnish flow 58, and push direction arrow 61. When a user presses down push button 12, valve 13c stays in a fixed position, while valve seat 13b moves down along with valve housing 13a. Valve housing 13a has an, opening on top that allows it to slide while valve 13c is in a stationary position. Top portion of valve 13c sticks out of the opening on top of valve housing 13a. After the valve seat 13b moves down, valve 13c is in an open (deployed) position, and then varnish flows from outside of valve housing 13a to inside of valve housing 13a from opening 69, and then goes outside of 13a from an opening in valve seat 13b. Varnish leaving valve housing 13a moves down channel 14 and then into nib 8a. Channel 14 has an end inside of cap 12b, and is in fluid communication with both valve housing 13a and nib 8a. Valve housing 13a also slides against channel 14, while channel 14 and valve 13c are in a fixed position.

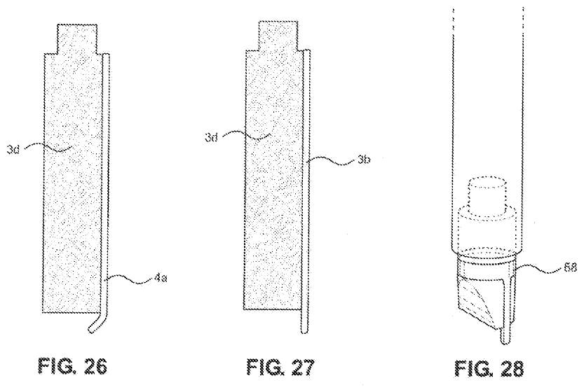

FIG. 28 illustrates a ring around a nib, and a guide 68 attached to the ring and extending below the lowest surface of the nib for contacting the nail. The nib of FIG. 28 can have grooves for accepting the ring and/or guide, so that the ring and the guide are flush and form a uniform surface.

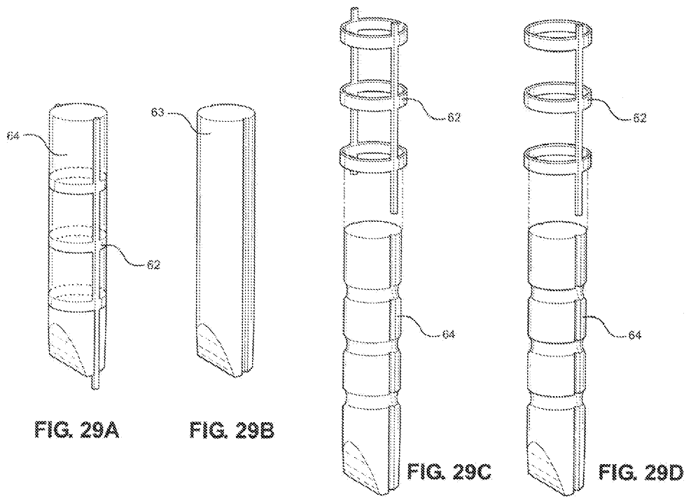

FIGS. 29 (and 29a, 29b, 29c, 29d) illustrates one or more rings and a guide 62 and an optional scaffold support. The nib 63 can have one or more grooves that run along the length of the nib for accepting the guide and/or the scaffold. The nib 64 can also have one or more grooves that run along in a horizontal manner for accepting one or more of the rings of guide 62. The rings/scaffold/guide 62 can be made from one piece of material and can be placed on the complementary grooves on the surface of the nib 63, 64, and can form a flush/uniform surface. The guide 62 can have one, two or three rings.

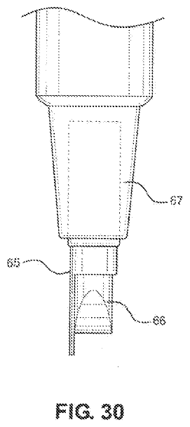

FIG. 30 illustrates a guide that is formed around nib 66 from a member that surrounds the upper portion of the nib 66 and is partially inside of the nail pen housing 67. In this embodiment, a circular member 65 which forms a guide goes around a portion of cylindrical nib 66 and its upper portion is placed inside of the nail pen housing 67.

The guide can be made of a hard material such as stainless steel and or hard plastic such as UItem™ (Polyetherimide).

Any of the nibs (such as 2e, 8) can be made of porous, pressed fibers such as felt. One option for the base material of porous nib can be PE (Polyethylene). Nib assembly 100 or other assemblies can have a total height that is about 1 to about 3 centimeters, such as about 2 to about 3 cm (such as 29.5 mm or 21.5 mm) and a diameter of about 2 mm to 8 mm, or about 3 mm to about 6 mm, such as about 5 mm or 4.5 mm (measured at a position of the nib that is placed inside the nail pen having the maximum diameter). Nib 2e is slanted on both sides to form a rectangular flat surface on its bottom with about 1 to 2 mm for the shorter side and about 2 to 6 mm for the longer side, such as about 1.5 mm for the shorter side and about 4 mm for the longer side. Guide 2f can protrude below the flat rectangular surface (measured in a vertical plane) of item 2e or other nib surfaces by approximately about 0.5 to about 3 mm, such as about 1 mm, or about 2 mm, or about 2.5 mm, and may be at an angle.

Varnish can move down any of the nibs by gravitational force and/or diffusion. The movement of varnish can further be accelerated by a mechanism that can put a force on the varnish inside of the pen to force the varnish into the nib. Nibs can be made of absorbent materials (soaks up varnish) and the guide is made from a non-absorbent (does not soak up varnish) material. Nibs can also be made from non-absorbent materials that with a particular type of varnish allow for movement of varnish. In this embodiment, the nibs can have substantial number of pores that allow the varnish to flow without being absorbed by the material that forms the nib.

Each of the nib and the guide can be made from a single unitary piece of material. A mold can be used to make the guide. The nib can be made from a cylindrical, shaped material that is cut at regular spaced intervals. Other manufacturing methods can be used. The nib and the guide can be made into an assembly by over molding without-use of adhesive, use of an adhesive, and/or use of a step (FIG. 14) that limits the movement of the guide.

The nib can be removably attached to the nib. The nib with or without the guide can be removably attached/inserted into the nail pen body. The nib with or without the guide can also be non-removably attached/inserted into the nail pen body. The assembly of the nib and the guide can be both disposable and removable from the nail pen, or alternatively permanently attached to the nail pen.

As illustrated for example in FIG. 2, nib 2e can have a cylindrical shape. The lower part of the nib can taper to form a surface for contacting a nail. The upper part of the nib can also taper, by having for example a smaller concentric cylinder. As illustrated in FIG. 14, the nib can further have a step or recess between a first lower portion and a second upper portion. The second upper portion would have a larger diameter to create a step with a thickness that complements the thickness of a guide that is placed on the lower portion of the nib.

Nib fiber construction is configured to allow for passage of high viscosity pigmented manicure varnish. Water based varnish can be made of water, methyldibromo glutaronitrile, acrylates copolymer, propylene glycol, titanium dioxide, propylene, glycol butyl ether, dipropylene glycol butyl ether, trimethyl pentanyl diisobutyrate, sodium pca, ammonium hydroxide, ppg-26-buteth-26, butoxyethanol, modified alkylaryl polyether, dimethicone, silica. Alcohol based varnish can be made of aqua/water/eau, acrylates/ethylhexyl acrylate copolymer, isopropyl alcohol, styrene/acrylates copolymer, propylene glycol, laureth-21, sodium acrylate/acryloyldimethyl taurate copolymer, phenoxyethanol, alumina, aminomethyl propanol, ammonium hydroxide, silica, methylparaben, propylparaben, ethylparaben, titanium dioxide (ci 77891). Alcohol based varnish can be made of alcohol denat., methoxyisopropanol, acrylates copolymer, acetyl triethyl citrate, nitrocellulose, peg-12 dimethicone, acetyl tributyl citrate. ci 77891 (titanium dioxide), aluminum hydroxide, ci 19140 (yellow 5 lake). Alcohol based varnish can be made of alcohol, methoxyisopropanol, acrylastes copolyrner.

In some embodiments, the guide may not come in contact with any portion of the nail pen and/or not be attached to the nail pen, and be in contact only with the nib. In some embodiments, the guide is only secured and held place by the nib without any support from any portion of a nail pen, even when a portion of the guide enters the cavity of the nail pen.

### REFERENCES

FIG. 1: Exploded view of manicure applicator

### 1. Barrel

2. Valve pump nib assembly

### 3. Cap

FIG. 2: Exploded view of valve/pump
2a. Valve housing
2b. Valve door
2c. Valve compression spring
2d. Valve compression spring retainer
2e. Nib
2f. Nib guide
100. Over-molded guided nib unit
FIG. 3: Side view of applicator assembly

### 1. Barrel

1a. Grip Knurl

### 3 Cap

3a. Cap screw knurl
FIG. 4: Applicator assembly cross section

### 1. Barrel

2a. Applicator nozzle
2b. Valve Stem
2C. Valve compression spring
2d. Valve spring retainer
2e. Nib
2f. Nib Guide
50. Nozzle seal area (part of cap screw)
51. Agitator ball
53. Nozzle/Barrel snap ring (mating rings)
54. Valve housing/valve retainer snap rings (mating rings)
FIG. 5: Guided nib overmold
2e. Nib
2f. Nib guide
100. Over-mold unit
FIG. 6: Guide, fused metal weldment (or non-metal)
2f. Nib guide
FIG. 7: Nib (isometric back view)
2e. Nib

### FIG. 7: Nib

2e. Nib
FIG. 8: Manicure application

### 56. Finger

### 57. Fingernail

55. Applied French manicure
2e. Nib
FIG. 8: Manicure application

### 56. Finger

### 57. Fingernail

55. Applied French manicure
2e. Nib
2f. Guide
FIG. 9: Nib compression stages

### A. Relaxed

### B. Compressed

F. Applied force

### 1. Barrel

2e. Nib
2f. Guide
58. Liquid flow (varnish)

### FIG. 10: Guided nib

3b. Metal or non-metal plate
3c. Adhesive
3d. Nib

### FIG. 11: Guided nib

4a. Metal or non-metal plate, slanted tip
3d. Nib
59. Metal or non-metal plate'bend

### FIG. 12

2e. Nib
5a. Metal or non-metal plate, slanted tip
60. Guide bend
101. Over-molded guided nib unit
FIG. 13: Center guided nib
6a. Nib
7a. Center guide phi shaft
7b. Center guide pin head
FIG. 14: Ferrule guided nib
3c. Adhesive (gap filling ultra-gel control for example LOCTITE BRAND ultra-gel adhesive)
8a. Nib
8b. Nib recessed area for ferrule mating
8c. Near slanted cut for narrow marking tip, 2 symmetrical places, near and far sides
8d. Marking tip surface
9a. Ferrule body
9b. Protruded ferrule guide
9c. Ferrule recessed side
FIG. 15: Rear push button manicure applicator

### 10. Body

### 11. Cap

12. Valved refill
FIG. 16: Rear push button manicure applicator
8. Ferrule guided nib assembly

### 10. Body

### 11. Cap

12. Valved refill

### FIG. 17: Valved Container

12a. Manicure liquid container
12b. Container cap
13. Valve/Pump assembly
51. Agitator ball
FIG. 18: Valve/pump assembly
13a. Valve/Pump housing
13b. valve seat
13c. Valve
13d. Compression spring
FIG. 19: Ferrule guided nib assembly
3c. Adhesive (gap filling ultra-gel control for example LOCTITE BRAND ultra-gel adhesive)
8a. Nib
9a Ferrule body
FIG. 20: Push button French manicure applicator normal position
8. Ferrule guided nib assembly

### 10. Body

12. Valved refill
FIG. 20: Push button french manicure applicator normal position
8a. Nib
9a. Ferrule body

### 10. Body

### 12. Valved Container

12b. Container cap
12c. Manicure liquid
13a. Valve Housing
13b. valve seat
13c. Valve
14. Manicure liquid feed channel
51. Agitator ball
58. Liquid flow

### 69. Side Openings

FIG. 21: Push button French manicure applicator pressed position
8. Ferrule guided nib assembly

### 10. Body

12. Valved refill
61. Push direction arrow
FIG. 21a Push button French manicure applicator pressed position
8a. Nib
9a. Ferrule body

### 10. Body

12. Valved container
12b. Container cap
12c. Manicure liquid
13a. Valve Housing
13b. valve seat
13c. Valve
14. Manicure liquid feed channel
51. Agitator ball
58. Liquid flow
61. Push direction arrow

### FIG. 22

6a. Cylindrical nib
7a. Shaft
7b. Pin head

### FIG. 23

8a. Nib
9a. Ferrule body
9b. Guide

### FIG. 24

6a. Nib

### 7. Guide

### FIG. 25

2e. Nib
60. Guide with bend

### FIG. 26

3d. Nib
4a. Guide

### FIG. 27

3b. Guide
3d. Nib

### FIG. 28

68. guide with ring

### FIG. 29

62. Guide with ring(s)
63. Nib with vertical groove
64. Nib with vertical and horizontal groove

### FIG. 30

### 65. Guide

### 66. Nib

67. nail pen housing

### FIG. 31

9c. Ferrule with lower heights (ring)

### FIG. 32

9d. Ferrule with a step

What is claimed is:

1. An assembly for a nail pen comprising:
a) a nib made from a material that is configured to allow for movement of varnish from inside of the nail pen to the nib, and from the nib to a surface of a nail;
b) a guide made from a material that is non-absorbent to the varnish, the guide extending below a surface of the nib that is configured to apply varnish to the nail;
wherein a user applies a strip of the varnish to a distal portion of the nail by holding the guide against an edge of the nail and moving the nail pen along the distal portion of the nail so that the surface of the nib holding the varnish contacts the distal portion of the nail to apply varnish to the nail;
wherein the nib and the guide are attached to each other to form the assembly.

2. The assembly of claim 1, wherein the assembly is configured to be removable from the nail pen.

3. The assembly of claim 1, wherein the assembly is cylindrical shaped.

4. The assembly of claim 1, wherein the guide is configured as a sleeve to be placed on an outside portion of the nib.

5. The assembly of claim 4, wherein the nib has an upper portion with a larger diameter than a lower portion with a smaller diameter, and the guide is placed on the lower portion of the nib with the smaller diameter.

6. The assembly of claim 5, wherein the sleeve and the a nib form a uniform surface.

7. The assembly of claim 1, wherein the guide is placed in an absent portion of a cylindrical nib.

8. The assembly of claim 1, wherein the nib is made from a single fabricated piece of the absorbent material, the nib having a channel inside at least along its top one fifth portion.

9. The assembly of claim 1, wherein the guide is configured to be on outside of the nib in an end of the nib configured to contact the nail, and the guide is configured to be inside of the nib in an end of the nib configured to contact a component of the nail pen.

10. The assembly of claim 1, wherein the guide is configured to be placed in a groove that is on an outer surface of the nib.

11. The assembly of claim 1, wherein the guide and the nib are coaxial at least in a top half end of the nib.

12. The assembly of claim 1, wherein the guide and the nib are coaxial with the guide running along a central axis of the nib, the guide further extending outside of an end of the nib.

13. The assembly of claim 1, wherein the assembly is configured to be placed in a cavity at a bottom end of the nail pen.

14. The assembly of claim 13, wherein both the guide and the nib enter the cavity of the nail pen.

15. The assembly of claim 13, wherein only the nib enters the cavity of the nail pen.

16. The assembly of claim 1, wherein the nib has a step.

17. The assembly of claim 1, wherein the guide is not attached directly to the nail pen.

18. An assembly for attaching to a nail pen holding varnish comprising:
a) a nib made from a material that is configured to allow for movement of varnish from inside of the nail pen to the nib, and from the nib to the nail, the nib further configured to make contact with a mechanism in the nail pen that is configured to allow for flow of varnish to the nib when the nib is pressed against the nail;
b) a guide made from a material that is non-absorbent to varnish, the guide extending below a surface of the nib that is configured to apply varnish to the nail;
wherein a user applies the varnish'to a distal portion of the nail by holding the guide against an edge of the nail and moving the nail pen along the distal portion of the nail so that the surface of the nib holding varnish contacts the distal portion of the nail.

19. The assembly of claim 18, wherein both the guide and the nib make contact with the mechanism.

20. A nail pen comprising:
a) a nail pen housing inside of which is a reservoir for varnish;
b) a valve to stop flow of varnish;
c) a mechanism configured to be actuated by a user to open the valve and allow varnish to flow to other side of the valve;
d) a nib made from a material that is configured to allow for movement of varnish from inside of the nail pen after the valve and to the, nib, and from the nib to a nail;
e) a guide that is non-absorbent to the varnish, the guide extending below a surface of the nib that is configured to apply varnish to the nail; and
f) a cavity at one end of the nail pen configured to receive the nib;
wherein a user applies a strip off the varnish to a distal portion of the nail by holding the guide against an edge of the nail and moving the nail pen along the distal portion of the nail so that the surface of the nib holding the varnish contacts the distal portion of the nail to apply varnish to the nail;
wherein the nib and the guide are in an assembly.
